(19) United States
(12) Patent Application Publication
(10) Pub. No.: US 2015/0043989 A1
(43) Pub. Date: Feb. 12, 2015

(54) WALL SCREW ANCHOR

(71) Applicant: Contendor AB, Stockholm (SE)

(72) Inventor: Lucas Lind, Stockholm (SE)

(21) Appl. No.: 14/383,187

(22) PCT Filed: Mar. 6, 2013
(86) PCT No.: PCT/SE2013/050196

§ 371 Date: Sep. 5, 2014

(30) Foreign Application Priority Data
Mar. 8, 2012 (SE) 1250213-4

(51) Int. Cl. F16B 35/06

(52) U.S. Cl. CPC F16B 35/06
USPC 411/80.1

(57) ABSTRACT

A self-drilling plasterboard screw anchor comprising: an elongated anchor element having a drill end, and opposite thereto, an end with means for engagement with a rotary tool and a threaded screw hole transverse to the length of the anchor element, suitable for engaging a screw or bolt, wherein said elongated anchor element is securely held by, or integral with, a flexible resilient member having a collar having an outer diameter greater than the drill end drilling diameter and a round, hollow, straight tubular section, which is suitable for accommodating the screw or bolt, and is disposed perpendicular to said anchor element and ends directly at said transverse threaded screw hole.

### TECHNICAL FIELD

The present invention relates to a novel screw anchor for use in walls, in particular drywalls or plasterboard. In particular it relates to a self-drilling plasterboard anchor of the type defined in the preamble to the accompanying claim 1.

### DESCRIPTION OF THE RELATED ART

It is known that it is notoriously difficult to provide strong and secure screw fastening into a wall of plasterboard, otherwise known as a drywall, wallboard, plasterboard, gypsum board. Pressed gypsum plaster between two paper surfaces in such plasterboard provides an easily mounted “dead” (i.e. non-moving, such as wood) wall in which cracks under paint or wallpaper will not appear, as can be the case with wood. One of the disadvantages of plasterboard is that it has no wood fibers to securely hold screw threads when mounting a shelf for example on such a wall. The wooden studs inside the wall are often inconveniently placed or spaced too far apart for mounting the shelf for example. Slightly barbed or ribbed plastic plug anchors have been used, which are pushed into a hole drilled in the plasterboard, whereafter the fastening screw is screwed into it, expanding the plug slightly and increasing the holding force. Even moderate loads however may easily cause failure, with the screw, anchor and often the surrounding paper and plaster being ripped out of the wall. If the wall shelf is removed, it is very difficult to remove such plug anchors without creating large unsightly holes in the wall.

If one had access to the interior of the wall behind the sheet of plasterboard it would be easy to place a large area washer or a plate before the nut on the fastening screw thus spreading the load on the plasterboard over a much larger area and permitting the plasterboard to support a much larger load, from the shelf for example, without being pulled out of the wall. But shelves, TV brackets, lamp brackets, hooks etc. are usually mounted long after the original wall construction, with the wall being closed and painted or wallpapered. Thus there are quite a number of plasterboard anchors which are designed to be inserted through a drilled hole of acceptable diameter in the plasterboard and then, completely unseen behind the wall plasterboard sheet, either expand flexible sides of a nut element, as a Molly anchor does, or toggle a winged nut element to a position perpendicular to the fastener screw and behind the plasterboard sheet as toggle bolts do. With a toggle bolt, the wings of the toggle nut are folded against a machine screw during insertion into a drilled hole in the plasterboard so that the folded toggle wings completely clear the plasterboard sheet into the wall, whereupon the machine screw is tightened, thereby spreading the toggle wings. This toggle bolt solution requires metal pin axles for the wings on the nut, making this metal element relatively expensive and complex to make. Also, all of these previously mentioned types of wall screw anchors, require a number of separate steps to secure the anchors: drilling a hole of appropriate diameter, inserting the unexpanded anchor into the drilled hole, tightening a machine screw for expansion or folding out. In the case of the Molly anchor, the machine screw is removed after expansion and then reinserted of replaced (with a hook screw for example). A toggle bolt must be mounted in the shelf bracket hole for example when it is inserted into the hole before folding out the wings.

Any speeding up of this process may provide significant savings in time and effort of installation. To this end, self-drilling anchors have been developed, where the drill bit after drilling serves a toggle nut to be disposed within the wall at right angles to the fastener screw for tightening up. Four such prior art solutions are described in EP0998635, US2009/0003962, U.S. Pat. No. 6,435,789 and U.S. Pat. No. 7,611,316 where a drill point in alignment with a screw collar and two shanks is provided with a cross screw head for rotation of the drill point for drilling through the plasterboard. When it has penetrated fully, the drill point is disposed to swing 90° in relation to the shanks to present a screw hole for the fastening screw, which, when tightened up now utilizes the drill point as a perpendicular behind the wall toggle. All of these designs require shanks with means to guide and pivot the drill point to its perpendicular position presenting the nut hole for the screw. This type of anchor, although somewhat complex appears to function when the space inside the wall is hollow. When the space behind the sheet of plasterboard is filled with insulation, the drill point with stick in the insulation and not move to the perpendicular position. The fastening screw will in this case often miss the hole, resulting in a very unsatisfactory fixing of the fastener screw.

US 2008/0253860 describes a similar construction but where the drill point toggle is spring biased towards its perpendicular position in an attempt to remedy the problem with a wall filled with insulation. In this prior art design, after drilling, the separate collar is ratcheted down a plastic trough sandwiching the plasterboard between the toggle and the fastening screw, which rests in the plastic trough and is slid therein towards the toggle, hopefully in alignment with the threaded hole, which is not always the case if the toggle element is impeded by insulation. The user is required to push the collar down the ratcheted trough and to break off the protruding portion of the trough. Assembly is complicated. It requires the installation of a spring means and is dependent on small pivot pins interacting with very small pin recesses in plastic. The construction is not robust perhaps prone to breakage (pivot pins). And this design still does not guarantee that the distal end of the fastening screw or bolt will enter the threaded hole, should the toggle not be aligned perpendicular to the trough Small pieces of insulation can easily come between the parts of this known anchor assembly when inserted, thereby preventing the anchor from assuming its perpendicular alignment position.

### SUMMARY OF THE INVENTION

The present invention proposes a wall screw anchor which completely removes the disadvantages of the prior art anchors described above. This is achieved in a self-drilling plasterboard anchor of the type defined in the preamble to claim 1 which has the novel features defined in the characterizing clause of claim 1.

Further inventive embodiments are defined in the subclaims.

The features and advantages of the present invention will be apparent with reference to the following description and attached drawings, describing and showing by way of example only one illustrative embodiment of the present invention.

### BRIEF DESCRIPTION OF THE DRAWINGS

One embodiment of the present invention will now be described with reference to the accompanying drawings, of which:

FIG. 1(a)-(e) shows various views of a combined drilling and anchor element,

FIG. 2(a)-(c) shows three views of a unitary plastic tube element,

FIG. 3(a)-(c) shows three views of the unitary plastic tube element with the drilling and anchor element inserted therein,

FIG. 4 shows the anchor assembly of FIG. 3 poised for drilling through a sheet of plasterboard using a manual or power screwdriver,

FIG. 5A shows folding up of the plastic screw tube and insertion of the entire anchor assembly into the drilled hole,

FIG. 5B shows the screw anchor assembly reassuming its original perpendicular configuration.

FIG. 6(a)-(e) shows the screwing in of a fastening screw into the screw tube, which is forced against insulation material into its proper position for fixing a load bearing object on the plasterboard wall.

FIG. 7 shows the tightened down anchor fixing the load bearing object on the plasterboard wall.

### DETAILED DESCRIPTION OF THE PREFERRED EMBODIMENTS

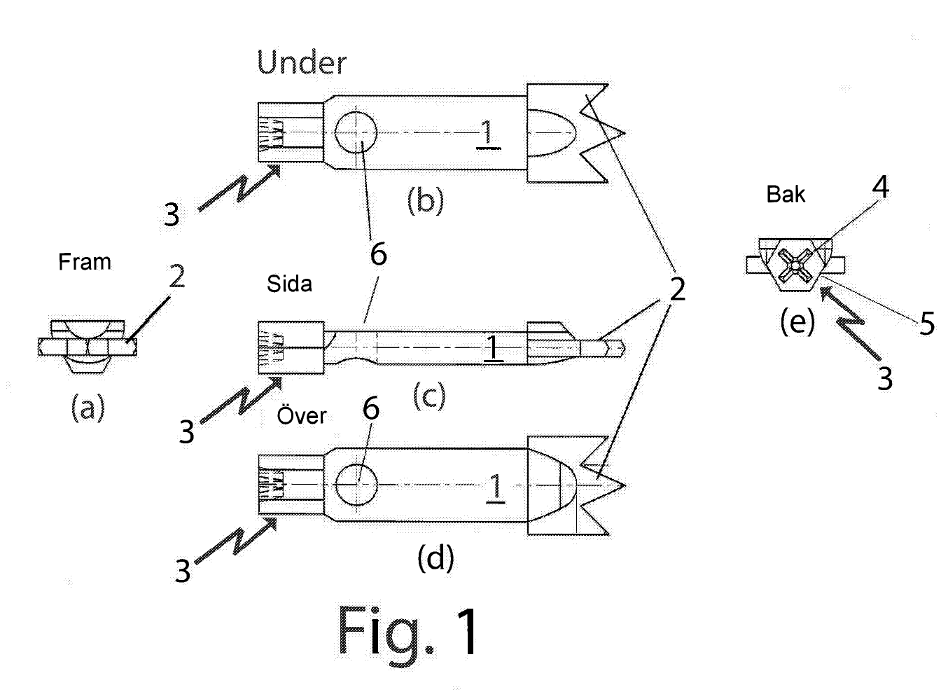

The combined drilling and anchor element is shown in FIG. 1 in 5 different views. In this embodiment it is made of cast metal, but is may just as well be made of plastic or other suitable material and has at one end a drilling head and at its tail end is provided with engagement means 3 for the purpose of rotating the element and drilling a hole through a sheet of plasterboard. It is also possible to make the combined drilling and anchor element in one integral piece, e.g. in plastic, with the combined drilling and anchor element. This one-piece plastic embodiment is not shown in the figures. Considerations of thread strength and heat resistance will dictate whether or not an entirely plastic one piece self-drilling anchor according to the invention is used.

The engagement means shown in the figures are dual, a cruciform recess 4 for a screwdriver bit, and a hex head 5 for engagement with a socket tool. It will be noted that this anchor can be installed using power as well as manual drivers. In the midsection of the drilling and anchor element there is a threaded hole 6 to receive the end of a fastening screw or bolt.

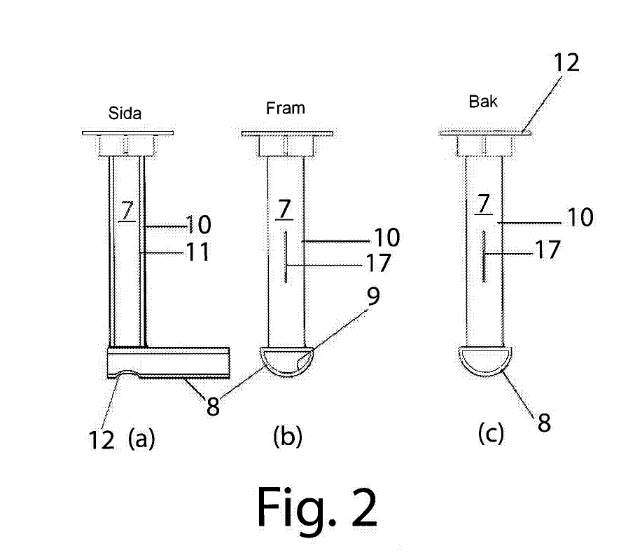

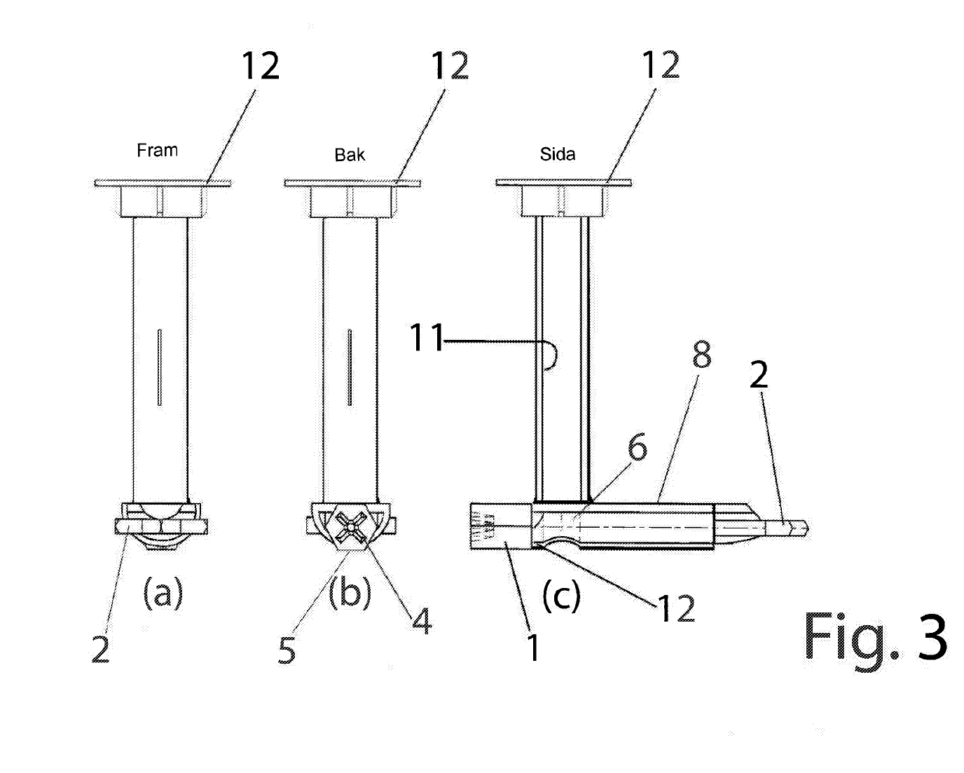

Three different views of the plastic tube element 7 are shown in FIGS. 2 (a)-(c), and is formed in one integral piece of resilient plastic, of a type and consistency tested to achieve optimal operation of the anchor. A tubular holder 8 has a hollow interior adapted exactly to the semi-circular cross section of drilling and anchor element which it is designed to receive upon assembly of the anchor assembly.

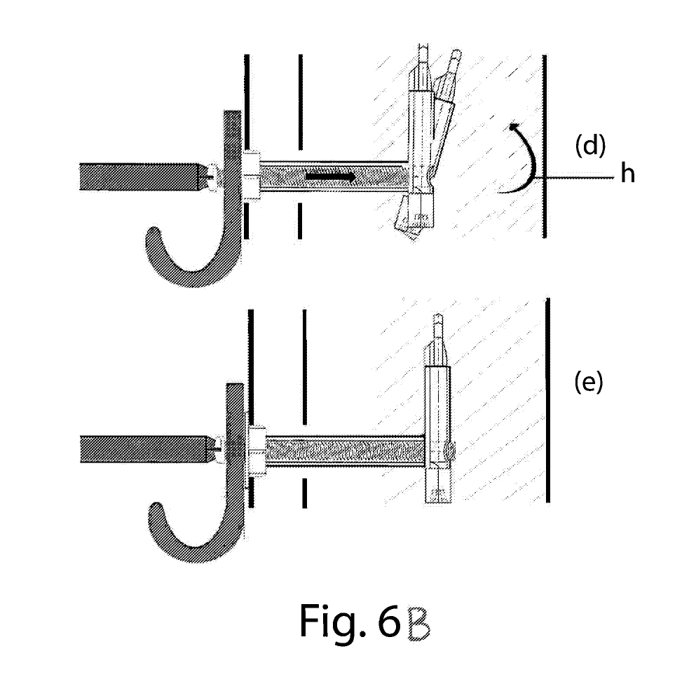

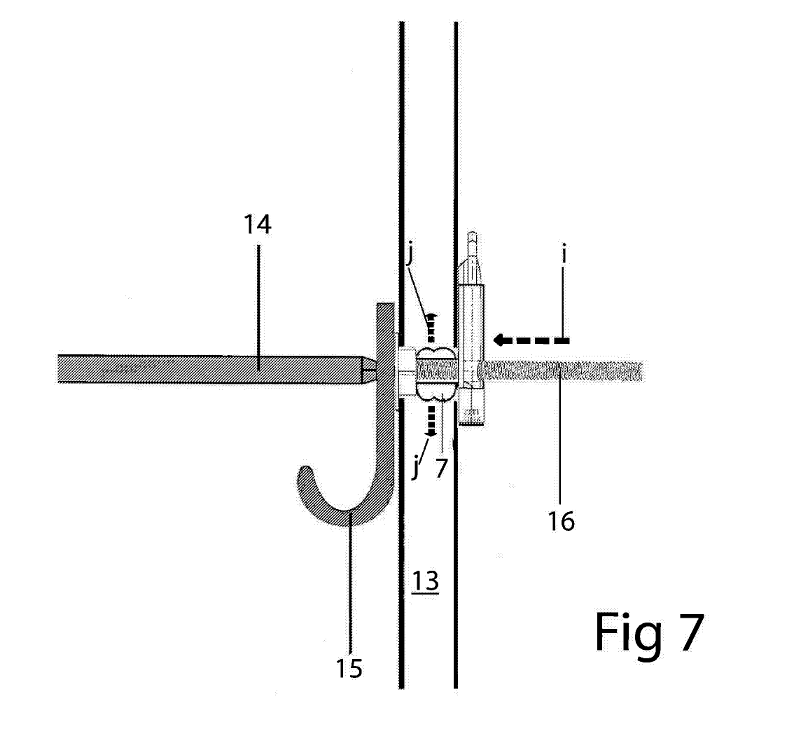

At right angles to the tubular holder 8, in one piece therewith, is a round hollow tubular section 10 having a round interior 11 which is slightly larger as the diameter of a screw or bolt (FIGS. 6 and 7) to be used with the anchor. The collar 12 of the round tubular section 10 has a slightly smaller interior diameter to engage the thread of the screw or bolt it is screwed in.

FIG. 3 shows three views (a)-(c) similar to FIG. 2 (a)-(c) but with the anchor element 1 held in the tubular holder 8, which has a through hole in precise alignment with the threaded hole 6 in the anchor element 1.

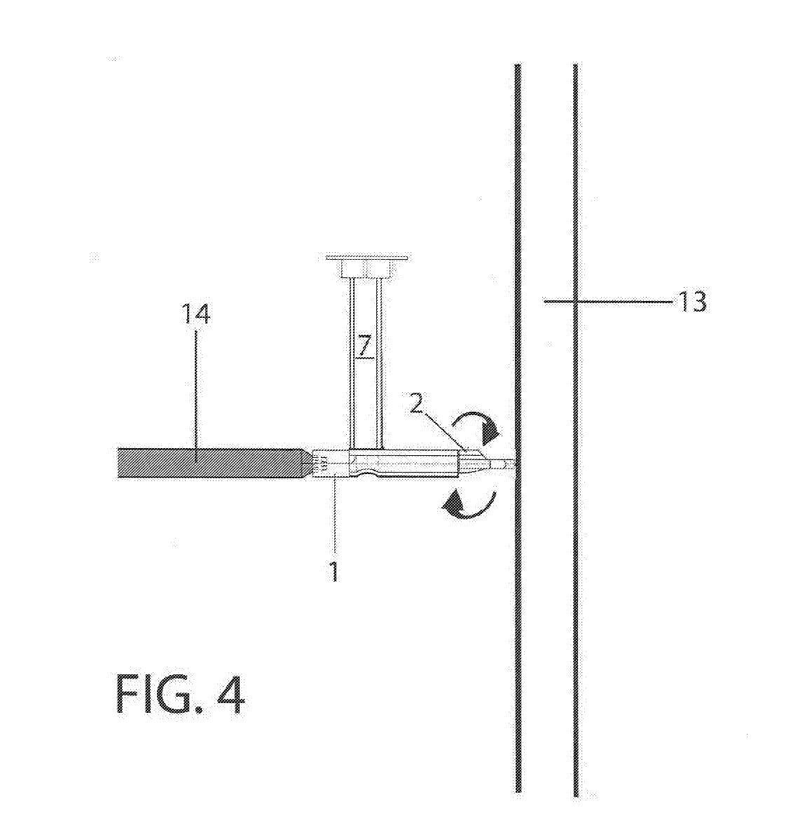

The operation of the inventive wall screw anchor is shown in FIGS. 4-7 for the mounting of a wall hook 15 on a plasterboard wall 13, which is usually 13.5 mm thick. It is also possible to use the very same anchor for double thick walls i.e. 27 mm. This is not possible for the prior art anchors, which must be available in two different versions for single or double plasterboard walls.

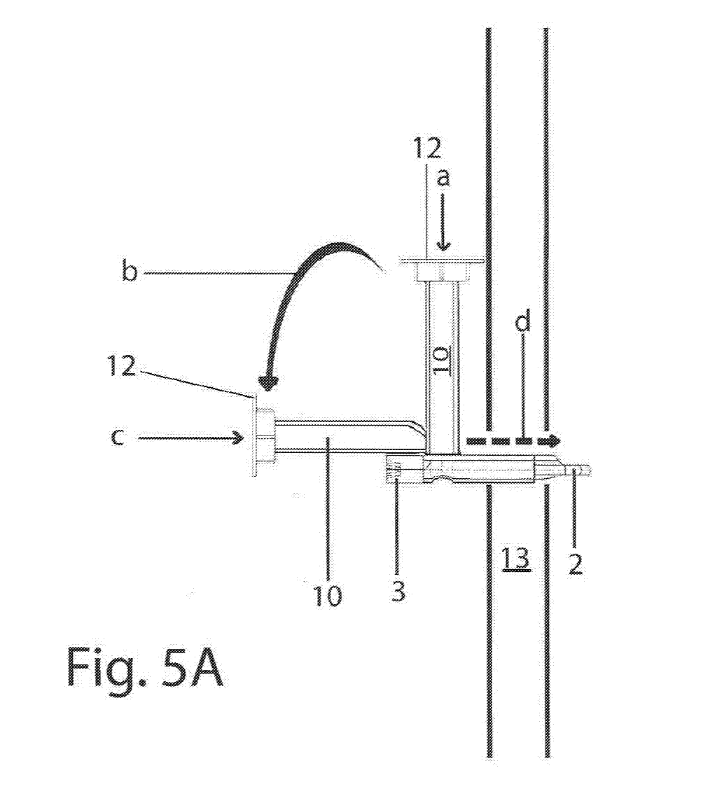

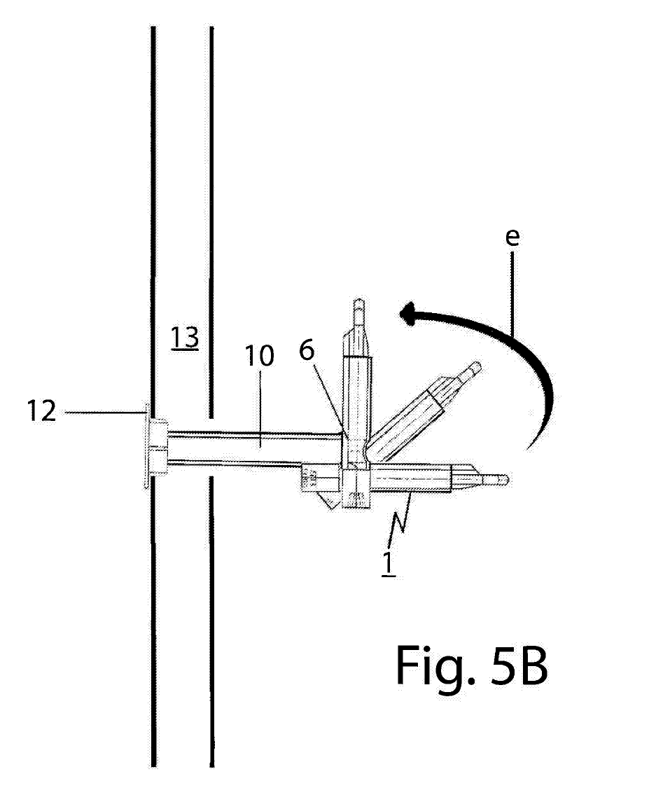

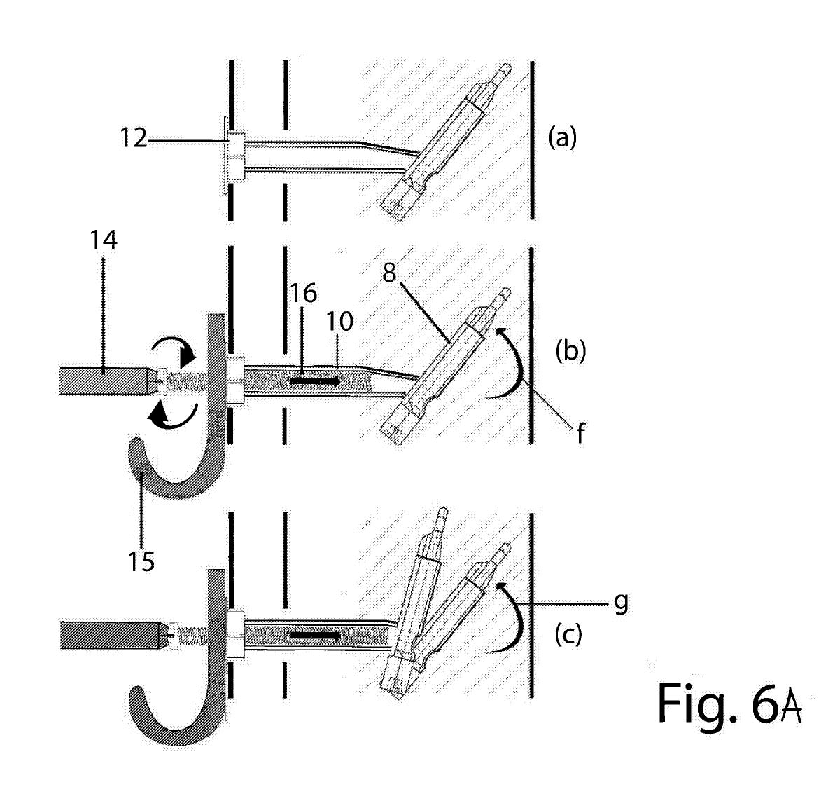

FIG. 4 shows the initiation of the drilling using a manual or power screwdriver 14 in this case. It is also possible to use a hex-socket driver to get a better grip and control. The rotating anchor assembly drills a hole through the plasterboard 13 as shown in FIG. 5A, halting when the collar 12 strikes the surface of the plasterboard (position a). The flexible tube 10 is then bent up (arrow b) to position c, whereupon the entire upright assembly is pushed (arrow d) into the drilled hole, which will have room for the flexible tube 10 since the cross-section of the anchor/drill element is a half circle, while the drilled hole is a full circle.

FIG. 5B shows the situation where the anchor element has been pushed completely into a hollow space behind the plasterboard wall. The anchor element and holder tube will automatically reassume their original perpendicular position (arrow e), with the round hollow tube 10 in precise alignment with the screw hole 6 in the anchor element.

The situation is quite different if there is insulation material or the like behind the plasterboard wall. Then the anchor element and holder will likely be held by the insulation in the position shown in FIG. 6(a), in which position the screw hole will not be in direct alignment with the round hollow tube. This is a problem encountered with the many different prior art screw anchors, leading to the screw never coming into screw engagement with the threaded hole, and which has never had a satisfactory remedy until the present invention.

The screw 16 is inserted through a mounting hole in a wall hook 15 for example and is screwed down in the collar 12 into the round hollow tube 10 as shown in FIG. 6 (b), with the screw hole 6 in the anchor element 1 still out of alignment with the screw. As the screw continues to be screwed downwards (see FIG. 6(c)) the screw starts to straighten out the tube, forcing the anchor element 1 and holder tube 8 towards their perpendicular position. This process is completed when the screw end reaches the threaded screw hole 6 of the anchor element (see FIG. 6(d)). It is now possible with continued screwing for the screw to come into screw engagement with the threaded screw hole 6 of the anchor element and to have the collar 12 and the anchor element 1 to move together.

As the anchor element held in the tube holder 8, is tightened up (arrows i) the walls of the round hollow tube 10 will expand radially (arrows j) as the tube is compressed axially. This will provide additional anchoring of the assembly beyond that already achieved by the compression forces between the collar 12 and the anchor element 1.

It should be noted that it is possible to mount the anchor, complete with drilling with a simple screwdriver and only two screwing steps are necessary to complete the mounting of the wall hook.

1. A self-drilling plasterboard screw anchor comprising:
an elongated anchor element (1) having a drill end (2), and opposite thereto, an end (3) with means for engagement with a rotary tool (14) and a threaded screw hole (6) transverse to the length of the anchor element, suitable for engaging a screw or bolt, characterized in that said elongated anchor element (1) is securely held by, or integral with, a flexible resilient member having a collar (12) having an outer diameter greater than the drill end (2) drilling diameter and a round, hollow, straight tubular section (10), which is suitable for accommodating the screw or bolt (16), and is disposed perpendicular to said anchor element and ends directly at said transverse threaded screw hole (6).

2. Anchor according to claim 1, characterized in that said flexible resilient member is made of semi-hard plastics material.

3. Anchor according to claim 1 or 2, characterized in that the elongated anchor element (1) is held in a hollow holder tube which has a semicircular cross section and is integral with said round hollow tubular section.

4. Anchor according to claim 1 or 2, characterized in that the elongated anchor element and the round hollow tubular section are a single piece of plastic.

5. Anchor according to one of the preceding claims, characterized in that the round tubular section has approximately the same inner diameter as the threaded screw hole (6) in the anchor element (1).

6. Anchor according to one of the preceding claims, characterized in that the round tubular section is provided with longitudinal slits (17) in its midsection, facilitating radial expansion beyond the diameter of the drilling end drilling diameter as the round tubular section (10) is longitudinally compressed, when a screw or bolt (16) is screwed into said threaded screw hole (6).
